(19) United States
(12) Patent Application Publication
(10) Pub. No.: US 2010/0058440 A1
(43) Pub. Date: Mar. 4, 2010

(54) INTERACTION WITH DESKTOP AND ONLINE CORPUS

(75) Inventors: Paul Yiu, Santa Clara, CA (US); Farzin Maghoul, Hayward, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/199,635

(22) Filed: Aug. 27, 2008

(51) Int. Cl. H04L 9/32

(52) U.S. Cl. 726/3

(57) ABSTRACT

A method is disclosed that includes gaining authenticated access to at least one of a restricted network device and a restricted online webpage with an authenticator integrated with a content crawler, wherein the authenticator is configured to obtain authentication data from a user for access to the at least one of the restricted network device and the restricted online webpage; indexing personal content of the at least one of the restricted network device and the restricted online webpage in a database; and enabling the user to search the indexed database based on a search query.

### BACKGROUND

1. Technical Field

The disclosed embodiments relate to systems and methods for interaction with desktop and an online corpus of a user, and more specifically, for an indexing system that enables acquisition and indexing of personal electronic content for subsequent search by the user.

2. Related Art

Internet search has grown in increasing popularity throughout the world. Users use online search engines to obtain information ranging from weather, sports, and news to research, and they are also used to shop for consumer or business products and services. In general, personalized information has gradually become more prevalent in electronic form, and its nature has made it difficult to search for in the same manner that a user may search for the news or for the best place to eat in a local community.

For instance, many people use email accounts, some of which include personal address books, retain healthcare information, and participate in personal or business social networking sites and blogs. Because personal electronic content is usually confidential in nature, access is usually restricted with forms of authentication, including firewalls, user identifications and passwords, encrypted access, security questions that only a user should know, and more sophisticated encryption such as hash algorithms. These forms of authentication are usually varied depending on not only the nature of the personal electronic content, but also where and by what it is stored and protected. For instance, this information for any given user may be distributed across desktop and laptop computers, mobile devices, and online Web pages, all potentially requiring user authentication for access. All of these factors have proved to be barriers to aggregating such personal electronic content by an automated search engine for the purposes of indexing it to provide users an opportunity to search for such information without fear that their personal information may be compromised or disclosed to others.

### SUMMARY

By way of introduction, the embodiments described below are drawn to systems and methods for interaction with desktop and an online corpus of a user, and more specifically, for an indexing system that enables acquisition and indexing of personal electronic content for subsequent search by the user.

In a first aspect, a method is disclosed for indexing content, including gaining authenticated access to at least one of a restricted network device and a restricted online webpage with an authenticator integrated with a content crawler, wherein the authenticator is configured to obtain authentication data from a user for access to the at least one of the restricted network device and the restricted online webpage; indexing personal content of the at least one of the restricted network device and the restricted online webpage in a database; and enabling the user to search the indexed database based on a search query.

In a second aspect, a method is disclosed for indexing content, including accepting authorization from a user, by a search engine crawler, to access at least one of a restricted network device and a restricted online webpage; obtaining, by an authenticator of the crawler and from a user-designated source, authentication data to gain the access to the at least one of the restricted network device and the restricted online webpage; supplying the authentication data by the authenticator to the at least one of the restricted network device and the restricted online webpage to gain access thereto; extracting personal content from the at least one of the restricted network device and the restricted online webpage to which the crawler gains authenticated access; indexing the personal content in a database according to at least one indexing method; and enabling the user to search the indexed database with specific search queries.

In a third aspect, a system is disclosed for indexing and searching personal content, including a search engine having a memory, a processor coupled with the memory, and a content crawler coupled with the memory and the processor. The content crawler includes an integrated authenticator configured to obtain authentication data from a user for access to at least one of the restricted network device and the restricted online webpage. A database is coupled with the content crawler and the processor. The processor is operable to index personal content of the at least one of the restricted network device and the restricted online webpage in the database, and enables the user to search the indexed database based on a search query.

In a fourth aspect, a system is disclosed for indexing and searching personal content, including a search engine having a memory, a processor, and a crawler coupled with the memory and the processor. The crawler accepts authorization from a user to access at least one of a restricted network device and a restricted online webpage. An authenticator is integrated with third-party, computer-implemented code within an online identity manager framework, wherein the authenticator is coupled with the crawler and is operable to obtain, through the online identity manager, authentication data that enables the content crawler to gain the access to the at least one restricted online webpage. The authenticator is further operable to obtain authentication data for the at least one restricted network device from identified user-designated sources. The content crawler is operable to extract personal content from the at least one of the restricted network device and the restricted webpage to which the crawler gains authenticated access. A database is coupled with the content crawler that is operable to store the extracted personal content. The processor is operable to index the personal content in the database according to at least one indexing method, wherein the search engine enables the user to search the database with specific search queries.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for gathering and indexing personal electronic content for the purposes of authenticated user search of the same.

FIG. 2 is another embodiment of the system of FIG. 1, showing additional detail related to the search engine, the crawler, and the carried authenticator.

FIG. 3 is a flow chart of an exemplary method for gathering and indexing personal electronic content for the purposes of authenticated user search of the same.

FIG. 4 is a flow chart of another exemplary method for gathering and indexing personal electronic content for the purposes of authenticated user search of the same.

### DETAILED DESCRIPTION

By way of introduction, this disclosure relates to systems and methods for interaction with desktop and online corpus of a user, and more specifically, for an indexing system that enables acquisition and indexing of personal electronic content for subsequent search by the user. Until now, no one has developed a search engine or system capable of automating the gathering and indexing of personal electronic content from the sources such as discussed in the above background. While the information need not all be indexed to provide search capability of such a search engine to users, indexing the information and requiring authenticated access to search on the indexed information provides a powerful, secure resource for quickly finding personal electronic data, especially when users are traveling or away from their homes. Personal electronic content may include social security numbers, personal codes and passwords, journal entries, written works, medical information, genealogy or family history, email and other correspondence, personal contacts and affiliated information, financial information to include bank accounts and statements, social networking data, and any other personal information not generally accessible to the public for search through search engines such as Yahoo! or Google.

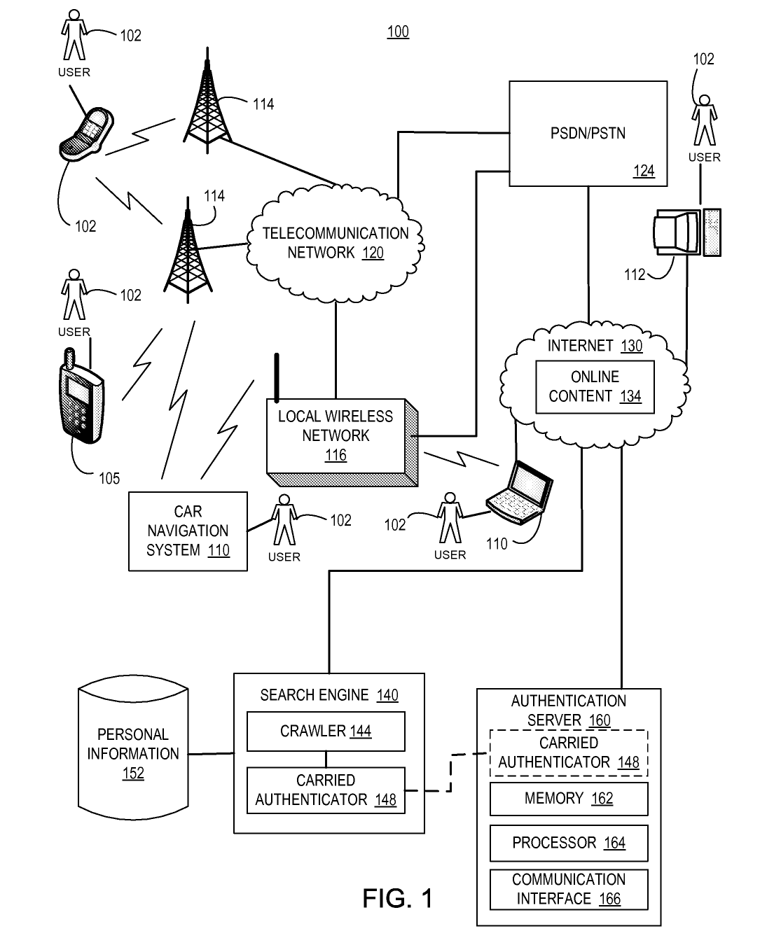

FIG. 1 is a diagram of an exemplary system 100 for gathering and indexing personal electronic content on behalf of any number of users 102 for the purposes of authenticated user search of the same. The system 100 may include mobile devices 105 such as cell phones, personal digital assistants (PDAs), Blackberry™ by Research in Motion, pagers, etc, semi-mobile devices 110 such as laptop computers, car navigation systems, etc., and fixed processing devices 112 such as desktop computers. The mobile devices 105 and semi-mobile devices 110 may wirelessly communicate with base transceiver stations 114, also referred to as cell cites or cellular towers, and local wireless networks 116. The local wireless networks 116 may include wireless connection and routing hardware, including a wireless antenna, hub, router, or the like (all not shown). The wireless connection of the wireless network 116 may involve WiFi, Bluetooth, 802.11a, 802.11b, or the like technology for passing networked data.

The system 100 may further include a telecommunication network 120 to which are coupled the transceiver base stations 114. Herein, the phrase “coupled with” is defined to mean directly connected to or indirectly connected through one or more intermediate components. The system 100 may further include a Public Switched Data (and/or Telephone) Network (PSDN/PSTN) 124 and an Internet 130 including online content 134, which itself may include personal electronic content. The system 100 may include a search engine 140 having a crawler 144, a carried authenticator 148, and a personal information database 152 to store personal electronic content. In some embodiments, the system 100 may further include an authentication server 160 coupled with the search engine 140 and through which is supplied the functionality of the carried authenticator 148. Accordingly, the carried authenticator 148 may be integrated with the search engine 140 or be coupled with the search engine 140, and thus the crawler 144, via an authentication server 160 or the like over a network, such as the Internet 130. The authentication server 160 includes a memory 162, a processor 164, and a communication interface 166 to facilitate the authentication of the crawler 144 by coupling it with the carried authenticator 148 as it crawls for personal electronic content or data, described in detail below.

The users 102 may connect through the mobile devices 105, the semi-mobile devices 110, and/or the fixed processing devices 112, which variably gain networked access to other user devices and to networks, including the Internet 130 or an intranet, through the PSDN/PSTN 124. The PSDN/PSTN 124 may be coupled with an Internet 130 or other network for communication with the search engine 140 and the authentication server 160, if employed. The Internet 130, as displayed, may encompass other networks such as a local area network (LAN), a wide area network (WAN), an ad hoc network, etc. The PSDN/PSTN 124 may include or be coupled with an Internet gateway (not shown) to facilitate access to the Internet 130.

The mobile devices 105 may transfer and receive digital, electronic personal content to and from the PDSN/PSTN 124 through the telecommunication network 120. The mobile devices 105 and/or the semi-mobile devices 110 may do the same to and from the PDSN/PSTN 124 through local wireless networks 116, which in some cases may connect directly to the Internet 130. Finally, fixed processing devices 112 such as desktop computers may connect directly into the Internet 130 in various manners, such as via dial-up, digital subscriber lines (DSL), cable, fiber-optics, etc., and through use of routers, switches, and other hardware that is directly connected into Internet connection points. The mobile devices 105, the semi-mobile devices 110, and the fixed processing devices 112 may variably be referred to herein jointly as networked devices (105, 110, 112).

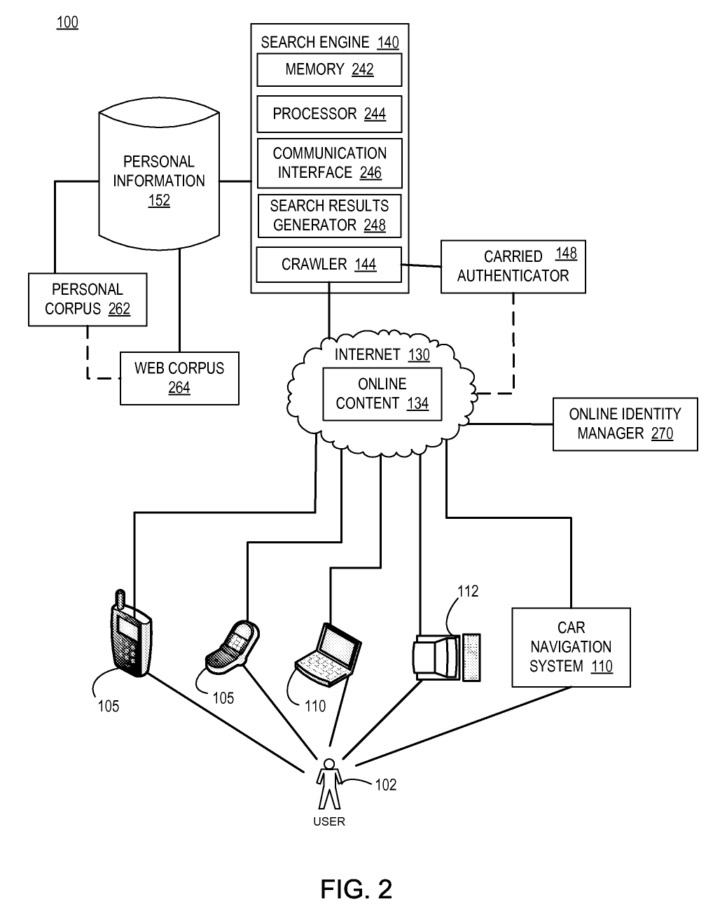

FIG. 2 is another embodiment of the system 100 of FIG. 1, showing additional detail related to the search engine 140, the crawler 144, and the carried authenticator 148. The same features discussed in FIG. 1 may be referenced but may not be explained in detail. The search engine 140 may further include a memory 242, a processor 244, a communication interface 246, and a search results generator 248. The personal information database 152 may further include a personal corpus 262 and a web corpus 264, wherein the personal corpus 262 is for storing personal electronic data from the networked devices (105, 110, 112) and the web corpus is for storing personal electronic data from online Web pages. Note that the personal electronic content considered a part of the personal corpus 262 may be stored in relation to that considered a part of the web corpus 264, thus integrating the two sets of data as far as the indexing is concerned, making it easy to retrieve data relevant to search results spanning across the two.

The crawler 144, which is coupled with the carried authenticator 148 as discussed with reference to FIG. 1, seeks and receives authorization from one or more users 102 to gain authenticated access on behalf of the users 102 to any of a number of networked devices (105, 110, 112) and online Web pages such as available over the Internet 103, an intranet, or other network. The Web pages may include a personal email account or online address book, an account with a consumer website, an account with a social networking site, a blog, or any number of Web pages that are owned by the users 102 or by third parties.

The carried authenticator 148 may receive identification data from a user-designated source, such as from a laptop (110) or desktop computer 112 of the user 102, a mobile device 105 of the user 102, an online password identity manager 270 of the user 102, or any other networked resource through which the user 102 may communicate with the carried authenticator 148. The identification data (or authentication information) may include, but is not limited to: user identifications (USERID's) and passwords, password length (where required), encrypted access keys, secrets, security questions that only the user 102 should know, levels of encryptions, clear text required for submission to hash algorithms, etc.

Note that the online identity manager 270 may include identification management as provided by the OpenID identity service. The OpenID shared identity service allows Internet users 102 to log on to many different websites using a single digital identity, eliminating the need for a different user name and password for each website. OpenID is a decentralized, free and open standard that lets users 102 control the amount of personal information they provide. Indeed, the OpenID allows integration of third party-generated code that provides newly-developed identity-related services to be deployed within the OpenID framework. Accordingly, the carried authenticator 148 may include code required to communicate with an OpenID provider (270) and various relying parties, e.g., commercial website owners, or may be deployed within the OpenID framework itself to secure access to the networked devices (105, 110, 112) and/or online Websites on behalf of the users 102.

Once the carried authenticator 148 obtains the identification or authentication information data, it may retain the identification or authentication information long enough to gain authenticated access for the crawler 144 to corresponding networked devices (105, 110, 112) and/or online Web pages. The carried authenticator 148 may be configured to cause the identification or authentication information to expire after a predetermined period of time, whether or not it has been used, or when the crawler 144 indicates it is finished extracting data. After gaining access with the aid of the carried authenticator 148, the crawler 144 may extract personal electronic content to accessed networked devices (105, 110, 112) and/or online Web pages. The extracted personal electronic content can then be stored in the personal information database 152, and with the help of the processor 244, be indexed according to any of a variety of indexing methods. For instance, personal contacts together with their contact information may stored in relation to each other, and any email sent or received from those personal contacts may conveniently be stored in relation to them as well.

The purpose of storing an index is to optimize speed and performance in finding relevant documents for a search query. Without an index, the search engine 140 would scan every document in the personal and/or web corpuses, 262, 264, which would require considerable time and computing power. Search engine indexing collects, parses, and stores data to facilitate fast and accurate information retrieval. Index design incorporates interdisciplinary concepts from linguistics, cognitive psychology, mathematics, informatics, physics and computer science. An alternate name for the process in the context of search engines designed to find Web pages on the Internet is Web indexing.

Popular engines, such as the search engine 140, focus on the full-text indexing of online, natural language documents; media types such as video and audio and graphics are also searchable. Meta search engines reuse the indices of other services and do not store a local index, whereas cache-based search engines permanently store the index along with the corpus 262, 264. Unlike full-text indices, partial-text services restrict the depth indexed to reduce index size. Larger services typically perform indexing at a predetermined time interval due to the required time and processing costs, while agent-based search engines index in real time. Any of a number of indexing methods, alone or combined, may be employed by the system 100 disclosed herein. The choice of the method is not important to the scope of the disclosure as one of ordinary skill in the art would make the choice based on whether or not a database is being merged, desired storage techniques, expected index size, lookup speeds, how the index is to be maintained, tolerance for faults or bad data, among other factors.

To be able to access the search features of the search engine 140, the user 102 may be required to submit a separate user name and/or password, or other authentication information, to the search engine 140. That is, the search engine 140 may have its own authentication requirements to ensure that users 102 are indeed authenticated for access to the confidential, personal electronic content accessible in the index of the personal and Web corpuses 262, 264. The user 102, once authenticated, may search the indexed personal information database 152 through submission of one or more specific keyword term(s) to a search input of the search engine 140 in attempts to find his or her personal information (such as for a friend's name, a bank account balance, or a piece of healthcare information). Submission of the search query may occur through a browser (not shown) of the user's networked device (105, 110, 112) that connects over the Internet 130 or other network with a search engine submission page (not shown) of the search engine 140.

The search results generator 248, in conjunction with the processor 244, may then search for information relevant to the keyword term(s), and generate a listing of data from the personal information database 152 for selection by the user 102. The search results may be returned to the user 102 through printing to a mobile device 105, to a computer screen of a laptop (110) or desktop computer 112, to a screen of a car's navigation system 110, etc. Such results may be updated automatically if the user 102 signs up for automatic updated search results relevant to certain keyword term(s). Such automatic updates may be provided by the crawler 148 directly after obtaining updated personal information relevant to the keyword term(s), or may be provided by the communication interface 246 of the search engine 140 after the updated personal information is stored in the personal information database 152. The updated information may be obtained through regular refreshing of data within the personal information database 152 with the crawler 144 and integrated carried authenticator 148. Through refreshing the data stored in the index of the personal information database 152, search results received by the users 102 will be more accurate and more likely to be updated.

The advantages of the system 100 includes the ability to automatically gather and keep updated a store of personal information to which a user 102 may gain authenticated access from any communication device with networked (and/or Internet) access. This means that users 102 may be able to easily, and seamlessly, gain access to their personal information through searching and through regular updates to a mobile device 105, for instance, allowing the users 102 to get such access while traveling, working, driving, when at a doctor's office or in a hospital, or at any time the user 102 requires such information. In an increasingly mobile society, the system 100 provides a powerful tool for personal data management and access.

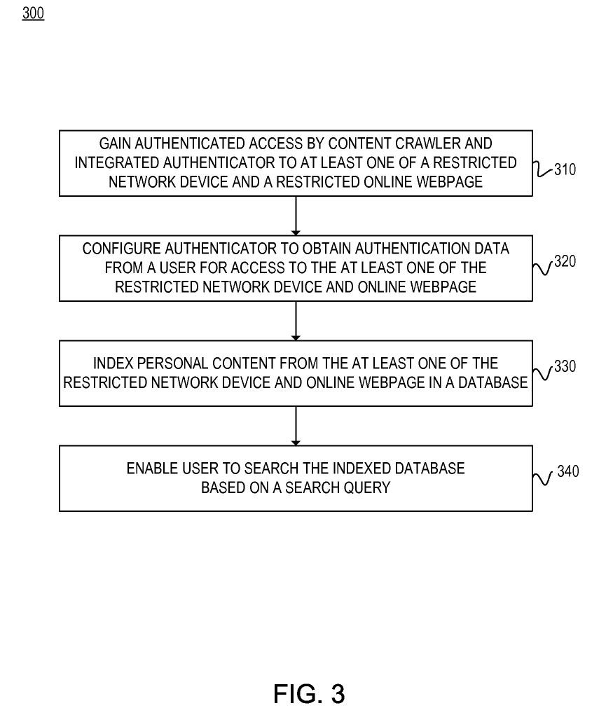

FIG. 3 is a flow chart 300 of an exemplary method for gathering and indexing personal electronic content for the purposes of authenticated user search of the same. The method includes, at block 310, gaining authenticated access to at least one of a restricted network device (105, 110, 112) and a restricted online webpage with an authenticator 148 integrated with a content crawler 144. At block 320, the authenticator 148 is configured to obtain authentication data from a user for access to the at least one of the restricted network device (105, 110, 112) and the restricted online webpage. At block 330, personal content of the at least one of the restricted network device (105, 110, 112) and the restricted online webpage is indexed in a database 152. At block 340, the user is enabled to search the indexed database 152 based on a search query.

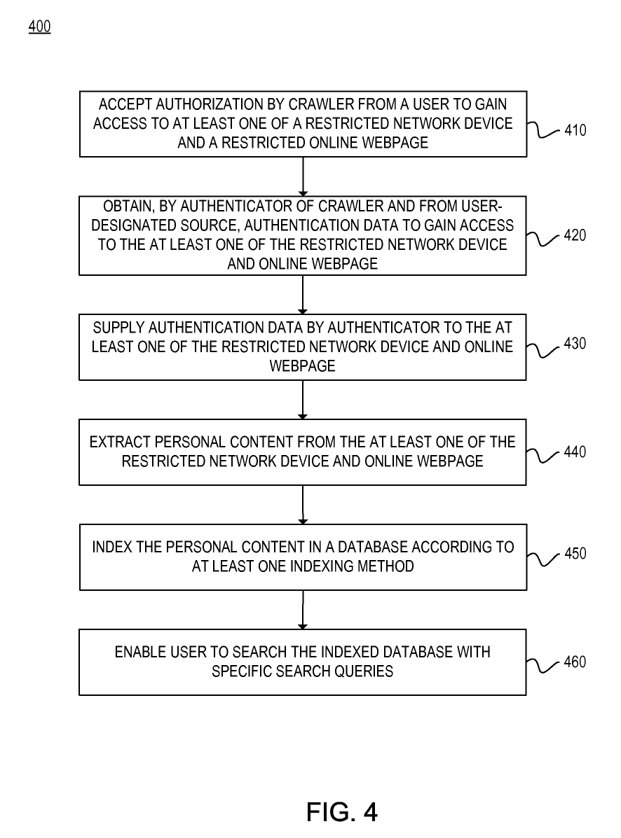

FIG. 4 is a flow chart 400 of another exemplary method for gathering and indexing personal electronic content for the purposes of authenticated user search of the same. The method includes, at block 410, accepting authorization from a user, by a search engine crawler 144, to access at least one of a restricted network device (105, 110, 112) and a restricted online webpage. At block 420, a carried authenticator 144 of the crawler 144 obtains, from a user-designated source, authentication data to gain the access to the at least one of the restricted network device (105, 110, 112) and the restricted online webpage. At block 430, the carried authenticator 144 supplies the authentication data to the at least one of the restricted network device (105, 110, 112) and the restricted online webpage to gain access thereto. At block 440, the crawler 144 extracts personal content from the at least one of the restricted network device (105, 110, 112) and the restricted online webpage to which the crawler 144 gains authenticated access. At block 450, the personal content is indexed in a database 152 according to at least one indexing method. At block 460, the user is enabled to search the indexed database with specific search queries.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for indexing content, the method comprising:
gaining authenticated access to at least one of a restricted network device and a restricted online webpage with an authenticator integrated with a content crawler, wherein the authenticator is configured to obtain authentication data from a user for access to the at least one of the restricted network device and the restricted online webpage;
indexing personal content of the at least one of the restricted network device and the restricted online webpage in a database; and
enabling the user to search the indexed database based on a search query.

2. The method of claim 1, further comprising:
receiving authorization from the user for the integrated authenticator and content crawler to access the at least one of the restricted network device and the restricted online webpage, wherein the user submits the authenticated data to the authenticator.

3. The method of claim 1, wherein the authenticator submits the identification data corresponding to the at least one of the restricted network device and the restricted online webpage to gain access thereto, the method further comprising:
extracting personal content from the at least one of the restricted network device and the restricted online webpage.

4. The method of claim 3, further comprising:
refreshing the indexed personal content of the database by periodically re-extracting the personal content from the at least one of the restricted network device and the restricted online webpage.

5. The method of claim 1, the method further comprising:
retaining the authentication data in the authenticator a sufficient period of time to enable the content crawler to gain authenticated access to the at least one of the restricted network device and the restricted online webpage; and
causing the identification data retained by the authenticator to expire after a predetermined period of time.

6. The method of claim 1, further comprising:
accepting a search query from the user;
comparing the search query with the indexed personal content to seek for a relevant match; and
returning to the user indexed personal content, as search results, that is relevant to the search query in response to finding a match.

7. The method of claim 6, further comprising:
requesting an authentication input from the user that submits the search query; and
verifying an identity of the user with the authentication input before returning the search results.

8. The method of claim 1, wherein the at least one of the restricted online webpage comprises a personal email account or address book, an account with a consumer website, an account with a social networking site, a blog, or a combination thereof.

9. A method for indexing content, the method comprising:
accepting authorization from a user, by a search engine crawler, to access at least one of a restricted network device and a restricted online webpage;
obtaining, by an authenticator of the crawler and from a user-designated source, authentication data to gain the access to the at least one of the restricted network device and the restricted online webpage;
supplying the authentication data by the authenticator to the at least one of the restricted network device and the restricted online webpage to gain access thereto;
extracting personal content from the at least one of the restricted network device and the restricted online webpage to which the crawler gains authenticated access;
indexing the personal content in a database according to at least one indexing method; and
enabling the user to search the indexed database with specific search queries.

10. The method of claim 9, wherein the user-designated source comprises one or more of a desktop of the user, a mobile device of the user, an online identity manager of the user, or a combination thereof, the method further comprising:
refreshing the indexed personal content of the database by periodically re-extracting the personal content from the at least one of the restricted network device and the restricted online webpage.

11. The method of claim 10, wherein the online identity manager of the user comprises OpenID.

12. The method of claim 9, the method further comprising:
retaining the authentication data in the authenticator a sufficient period of time to enable the content crawler to gain authenticated access to the at least one of the restricted network device and the restricted online webpage; and
causing the identification data retained by the authenticator to expire after the crawler finishes extracting personal content from the at least one of the restricted network device and the restricted online webpage.

13. The method of claim 9, further comprising:
accepting a search query from the user;
comparing the search query with the indexed personal content to seek for a relevant match; and
returning to the user indexed personal content, as search results, that is relevant to the search query in response to finding a match.

14. The method of claim 13, further comprising:
requesting an authentication input from the user that submits the search query; and
verifying an identity of the user with the authentication input before returning the search results.

15. The method of claim 9, wherein the plurality of networked devices comprise a mobile device, a car navigation system, a personal computer, a laptop computer, or a combination thereof.

16. A personal content search system comprising:
a search engine having a memory, a processor coupled with the memory, and a content crawler coupled with the memory and the processor, wherein the content crawler includes an integrated authenticator configured to obtain authentication data from a user for access to at least one of the restricted network device and the restricted online webpage; and
a database coupled with the content crawler and the processor;
wherein the processor is operable to index personal content of the at least one of the restricted network device and the restricted online webpage in the database, and enables the user to search the indexed database based on a search query.

17. The system of claim 16, further comprising a communication interface coupled with the processor, wherein the communication interface receives authorization from the user for the integrated authenticator and content crawler to access the at least one of the restricted network device and the restricted online webpage, wherein the user submits the authenticated data to the authenticator.

18. The system of claim 16, wherein the content crawler is operable to extract personal content from the at least one of the restricted network device and the restricted online webpage and store the person content, as indexed by the processor in the database.

19. The system of claim 16, wherein the search engine further comprises a communication interface coupled with the processor and operable to accept as input from the user the authentication data, wherein the authenticator retains the authentication data a sufficient period of time to enable the content crawler to gain authenticated access to the at least one of the restricted network device and the restricted online webpage, wherein after a predetermined period of time the identification data expires.

20. The system of claim 19, wherein the authentication data comprises one or more of: user identifications (USERID's), passwords, password length, encrypted access keys, secrets, security questions, levels of encryption, clear text strings, or a combination thereof.

21. The system of claim 16, wherein the processor enables the user to approve access of the content crawler to personal content located on the at least one of the restricted network device and the restricted online webpage.

22. The system of claim 16, wherein the search engine further comprises a communication interface coupled with the processor and operable to accept a search query from the user, wherein the processor compares the search query with the indexed personal content to seek for a relevant match;
wherein the communication interfaces returns indexed personal content, as search results, to the user that is relevant to the search query in response to finding a match.

23. The system of claim 22, wherein the communication interface requests an authentication input from the user that submits the search query, and verifies identity of the user with the authentication input before returning the search results.

24. A personal content search system comprising:
a search engine having a memory, a processor, and a crawler coupled with the memory and the processor, wherein the crawler accepts authorization from a user to access at least one of a restricted network device and a restricted online webpage;
an authenticator integrated with third-party, computer-implemented code within an online identity manager framework, wherein the authenticator is coupled with the crawler and is operable to obtain, through the online identity manager, authentication data that enables the content crawler to gain the access to the at least one restricted online webpage;
wherein the authenticator is further operable to obtain authentication data for the at least one restricted network device from identified user-designated sources;
wherein the content crawler is operable to extract personal content from the at least one of the restricted network device and the restricted webpage to which the crawler gains authenticated access; and
a database coupled with the content crawler that is operable to store the extracted personal content, wherein the processor is operable to index the personal content in the database according to at least one indexing method, wherein the search engine enables the user to search the database with specific search queries.

25. The system of claim 24, wherein the user-designated sources comprise one or more of a desktop of the user, a mobile device of the user, a semi-mobile device of the user, or a combination thereof.

26. The system of claim 24, wherein the online identity manager comprises OpenID.

27. The system of claim 24, wherein the authenticator retains the authentication data a sufficient period of time to enable the content crawler to gain authenticated access to the at least one of the restricted network device and the restricted online webpage; and
wherein the identification data expires after the crawler finishes extraction of the personal content from the at least one of the restricted network device and the restricted online webpage.

28. The system of claim 24, wherein the authentication data comprises one or more of: user identifications (USERID's), passwords, password length, encrypted access keys, secrets, security questions, levels of encryption, clear text strings, or a combination thereof.

29. The system of claim 24, wherein the search engine further comprises a communication interface operable to accept a search query from the user, wherein the processor compares the search query with the indexed personal content to seek for a relevant match;
wherein the communication interfaces returns indexed personal content, as search results, to the user that is relevant to the search query in response to finding a match.

30. The system of claim 29, wherein the communication interface requests an authentication input from the user that submits the search query, and verifies identity of the user with the authentication input before returning the search results.
